(19) United States
(12) Patent Application Publication
(10) Pub. No.: US 2024/0178729 A1
(43) Pub. Date: May 30, 2024

(54) METHOD FOR INSTALLING COIL GROUPS IN AN ELECTRIC MACHINE

(71) Applicant: LIEBHERR-AEROSPACE TOULOUSE SAS, TOULOUSE (FR)

(72) Inventors: Mathieu COUDERC, TOULOUSE (FR); François RAMADOUR, TOULOUSE (FR)

(73) Assignee: LIEBHERR-AEROSPACE TOULOUSE SAS, TOULOUSE (FR)

(21) Appl. No.: 18/283,809

(22) PCT Filed: Mar. 22, 2022
(86) PCT No.: PCT/EP2022/057541

§ 371 Date: Sep. 24, 2023

(30) Foreign Application Priority Data
Mar. 23, 2021 (FR) 2102912

(51) Int. Cl. H02K 15/00; H02K 3/38; H02K 15/10

(52) U.S. Cl. CPC H02K 15/0043; H02K 3/38; H02K 15/105

(57) ABSTRACT

The invention relates to a method for installing coil groups in an electric machine (100), each coil group (104, 204) comprising at least one coil, each coil being composed of a plurality of turns of conductors, characterized in that it comprises, for each coil group (104, 204), the following installation steps applied to each coil group before being applied to the following coil group: a step of inserting a first coil group into at least two free or partially occupied slots (106) of the electric machine (100), the coil portions arranged outside the slots forming the coil heads, a definitive shaping step by compacting the heads of the coils of said coil group into a predetermined shape, by a preconfigured apparatus.

### TECHNICAL FIELD OF THE INVENTION

The invention relates to a method for installing coil groups in an electric machine. In particular, the invention relates to a method for installing coil groups in a stator or a rotor of an electric generator and/or motor.

### TECHNOLOGICAL BACKGROUND

Methods for installing coil groups in an electric machine are operations generally performed, for the most part, manually, in particular in an aeronautical or space industry context. These operations consist in particular of inserting conductors forming the coils into slots, in particular stator or rotor slots of an electric generator and/or motor.

The conductors forming a coil are wound around the stator or rotor to form turns of the coil. The slots define paths for the conductors to pass through, making it possible to keep the conductors in position.

When the conductors forming a coil are inserted into the predetermined slots, the coil portions arranged outside the slots are called the coil heads. These coil heads protrude from the electric machine and are shaped to reduce their size. Owing to the inter-crossing of some coils, additional insulation can be placed between each coil in contact or likely to come into contact with another coil so as to prevent the transmission of electric current.

Currently, shaping of the coil heads, often manual, can be effected during the installation of each coil, and final compacting is performed after all of the coils have been inserted. Compacting makes it possible to reduce the size of the coil heads by making them take their final shape.

The current installation methods have a number of disadvantages. In particular, the final compacting operation has a major disadvantage of reducing control of the insulation between the coils of the electric machine because it causes the conductors to move with respect to each other and causes the insulators between conductors to move. These movements cannot be controlled and are thus uncontrolled, which means that it is not possible to guarantee correct insulation when a large amount of compacting is required. However, the insulation between the coils is critical, in particular when the coils form different phases of the electric machine, and in particular in electric motors supplied with power by pulse width modulation (PWM).

The inventors have thus sought a solution making it possible to guarantee effective insulation between the coils which should be insulated.

Furthermore, this final compacting operation is not compatible with enhancing control of the position of the conductors within the electric motor stators with flexible wire conductors inserted loosely.

### AIMS OF THE INVENTION

The invention aims to provide a method for installing coil groups in an electric machine making it possible to guarantee the insulation and the size of the installed coils.

The invention aims in particular to provide, in at least one embodiment, an installation method making it possible to simplify the placing of insulation between the coil heads.

The invention also aims to provide, in at least one embodiment of the invention, an installation method making it possible to reduce the size of the coil heads.

The invention also aims to provide, in at least one embodiment of the invention, an installation method in which the conductors are less susceptible to undesired movement during compacting operations.

The invention also aims to provide, in at least one embodiment of the invention, an installation method having improved reproducibility.

### DESCRIPTION OF THE INVENTION

To this end, the invention relates to a method for installing coil groups in an electric machine, each coil group comprising at least one coil, each coil being composed of a plurality of turns of conductors, characterized in that it comprises, for each coil group, the following installation steps applied to each coil group before being applied to the following coil group:
a step of inserting a first coil group into at least two free or partially occupied slots of the electric machine, the coil portions arranged outside the slots forming the coil heads,
a definitive shaping step by compacting the heads of the coils of said coil group into a predetermined shape, by a preconfigured apparatus.

An installation method in accordance with the invention thus makes it possible to control the positioning of the different coils arranged in coil groups and to control the compacting force on each of the coils. The sequential performance of the installation steps allows improved robustness in the obtained result compared to that provided when installing coil groups. In particular, the method is more reproducible and makes it possible to obtain coil heads having a reduced size and facilitated, and thus guaranteed, insulation compared with the prior art where the movements of the coils with respect to each other during final compacting can jeopardize the reliability of the insulation.

In particular, the shaping for each coil is definitive owing to a compacting step which cancels out the spring effect of the conductors of the coils. Each coil group thus assumes a predetermined and fixed shape prior to installation of the next coil group. It is this predetermination of the size of each coil group and this definitive shaping which make it possible to obtain the reproducibility which facilitates the reduction of the overall size of the coil heads and the reliability of the insulation. Compacting is three-dimensional compacting in the sense that the predetermined shape assumed by each coil group lies within a predetermined three-dimensional space obtained by compacting. The three-dimensional space can be the result of compacting according to one or several radial components and/or one or several axial components, it being understood that an axial compacting component can have consequences radially on the space taken up by the coil group and that a radial compacting component can have consequences axially on the space taken up by the coil group, according to the apparatus used.

Compacting can be effected by special tools so as to obtain, for each coil group, an optimized shape for the compacted coil heads.

Each coil group can comprise one or more coils: each coil group comprises the coil(s) which can be inserted at the same time for the purpose of their configuration in the slots, and shaped at the same time by the definitive shaping step. Each coil group can comprise a number different to the other coil groups. The number of coils, the type of coils (phase type formed by this coil for example) and their placement in the slots are thus taken into account in advance in order to specify the coil groups and perform the method with these predetermined coil groups.

Advantageously and in accordance with the invention, the installation steps comprise a step of placing insulation on the compacted coil heads if a coil group is to be subsequently installed and/or if a coil connection to a power supply requires said insulation.

According to this aspect of the invention, the installation of the insulation is facilitated after definitive shaping of the coil groups, and the risk of the insulation moving is greatly minimized because the definitively shaped coils do not move during installation of the following coil group(s). The insulation of each coil group is thus guaranteed.

The insulation is placed if a coil group is to be subsequently installed or if a connection of the coils to a power supply requires this insulation, generally when all of the coil groups are installed.

According to other variants of the invention, the insulation may be included in advance in all or some of the coils (enameled conductor for example) and the addition of insulation between the coil groups is not necessary depending upon the coils installed.

Advantageously and in accordance with the invention, each coil group is shaped so as to take up a space substantially extended in a different main plane for each coil group, the main planes of the coil groups being substantially parallel.

According to this aspect of the invention, the arrangement of the coil groups in separate spaces distributed in several planes makes it possible in particular to avoid the risks of already definitively shaped coil groups moving during shaping of the following coil groups by compacting.

Advantageously and according to these latter aspects of the invention, insulation is arranged substantially in a plane parallel to the main planes of the coil groups, between two main planes of coil groups which must be insulated with respect to each other.

According to this aspect of the invention, the separation of the coil groups in several planes makes it possible to greatly simplify the installation of the insulation if this is necessary, since insulation can be effected in a parallel plane between two main planes of coil groups and does not need to be managed coil-by-coil.

Advantageously and in accordance with the invention, the shaping step comprises, for at least one coil group, a step of bringing the coil group to temperature.

Advantageously and in accordance with the invention, the step of bringing the coil group to temperature comprises a sub-step of heating the coil group held in compacted shape to a temperature greater than or equal to 100° C. for a predetermined duration, a sub-step of cooling the coil group held in compacted 20 shape, and a sub-step of relaxing the compacting of the cooled coil group.

According to this aspect of the invention, the step of bringing to temperature makes it possible to reinforce the positioning of the coil group by fixing the position of the coil(s) of the installed coil group. The temperature applied can even be well above 100° C. depending upon the materials used to form the coil conductors.

This optional step can be implemented in particular when there is a large quantity of conductors forming the coil heads of the coil group, for example because there is a large number of conductors in the coil group and/or because a long conductor length projects beyond the slots of the machine for forming the coil heads. It is in this case that the risks of the conductors moving after compacting are the highest.

Within a single installation method for a single electric machine, this step can be implemented for one or more coil groups and not implemented for one or more other coil groups.

According to other embodiments of the invention, other methods can be implemented in the step of definitive shaping, for example hammering the coil group until the definitive shape is achieved.

Advantageously and in accordance with the invention, the shaping step comprises compacting according to at least one component, referred to as axial component, compacting the coil heads in a direction perpendicular to a surface of the electric machine and towards said surface of the electric machine.

Advantageously and in accordance with the invention, the shaping step comprises compacting according to at least one component, referred to as radial component, compacting the coil heads in a direction perpendicular to a main axis of the electric machine in a compacting direction directed away from said main axis of the electric machine and towards the exterior of the electric machine.

Advantageously and in accordance with this latter variant of the invention, the compacting is directed towards the exterior, bearing against an inner surface of a shaping tool.

The invention also relates to a device assisting the installation of the coil group, characterized in that it is configured to perform, after the installation of each coil, the step of shaping by compacting of the installation method in accordance with the invention, and comprising a compression tool configured to exert a force on the coil heads according to one or more radial components and a shaping tool surrounding the coil heads and configured such that the coil heads bear against an inner surface of the shaping tool when they are compressed by the compression tool.

According to this aspect of the invention, each compacted coil group will be able to be compressed using the same compression tool/shaping tool pairing, or even the compression tool and the shaping tool can each be different depending upon the coil groups so as to obtain the compacted coil group shapes having a minimum size.

The invention also relates to an electric machine, comprising slots intended to receive coils, characterized in that it comprises coil groups installed by implementing an installation method in accordance with the invention.

The invention also relates to an installation method, an assistance device and an electric machine, which are characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic view of an installation method in accordance with one embodiment of the invention,

FIG. 2a is a schematic, perspective view of an electric machine and an assistance device in accordance with one embodiment of the invention, during a first step of installing a first coil group in accordance with an installation method in accordance with one embodiment of the invention,

FIG. 2b is a schematic, perspective view of an electric machine and an assistance device in accordance with one embodiment of the invention, during a second step of installing a first coil group in accordance with an installation method in accordance with one embodiment of the invention,

FIG. 3a is a schematic, perspective view of an electric machine and an assistance device in accordance with one embodiment of the invention, during a first step of installing a second coil group in accordance with an installation method in accordance with one embodiment of the invention,

FIG. 3b is a schematic, perspective view of an electric machine and an assistance device in accordance with one embodiment of the invention, during a second step of installing a second coil group in accordance with an installation method in accordance with one embodiment of the invention,

FIG. 4a is a schematic, perspective view of a simplified electric machine in which coil groups have been installed by an installation method in accordance with one embodiment of the invention,

FIG. 4b is a schematic, perspective view of an electric machine in which coil groups have been installed by an installation method in accordance with one embodiment of the invention.

### DETAILED DESCRIPTION OF AN EMBODIMENT OF THE INVENTION

In the figures, for the purposes of illustration and clarity, scales and proportions have not been strictly respected.

Furthermore, identical, similar or analogous elements are designated by the same reference signs in all the figures.

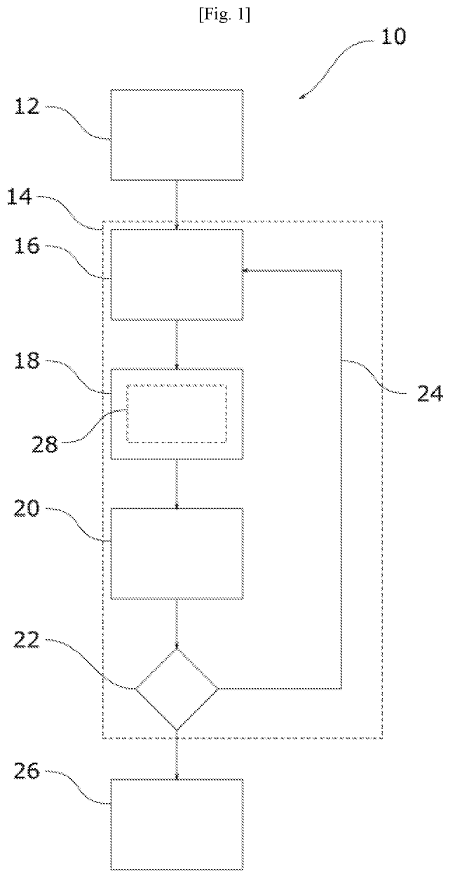

FIG. 1 schematically illustrates an installation method 10 in accordance with one embodiment of the invention. The installation method 10 makes it possible to install coil groups in an electric machine, for example a stator of an electric generator and/or motor, each coil group comprising at least one coil, each coil being composed of a plurality of turns of conductors.

The installation method 10 comprises a preliminary step 12 of specifying the installation of coils in an electric machine. The aim of this specifying step 12 is to specify, from all of the coils to be installed, the coil groups which are to be inserted in the electric machine, the way in which the compacting of the coil heads will be effected, the placement of the possible insulations, etc. This specifying step 12 is performed in advance in a design phase of the electric machine.

The installation method then comprises steps 14 of installing the coil groups in the electric machine following the predetermined parameters.

In particular, the installation steps 14 are applied to each coil group before being applied to the following coil group and comprising in particular:
a step 16 of inserting a first coil group into at least two free or partially occupied slots of the electric machine, the coil portions arranged outside the slots forming the coil heads;

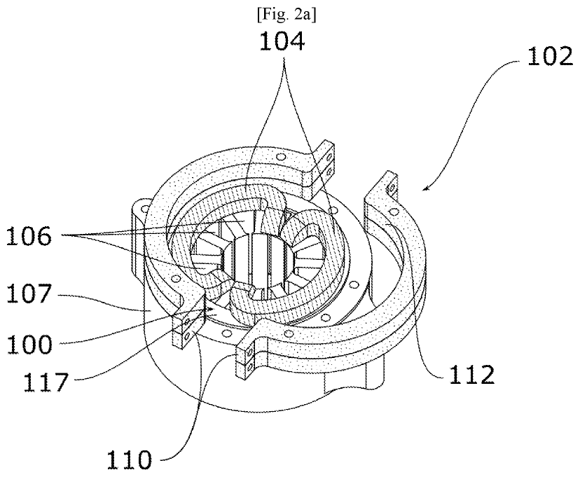

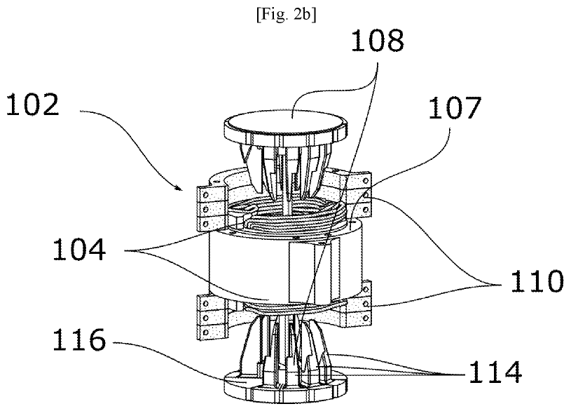

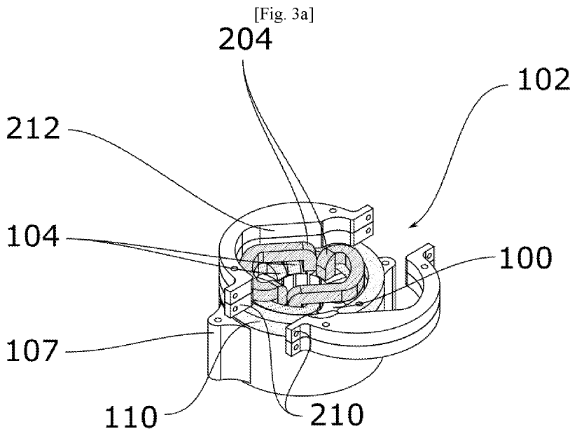

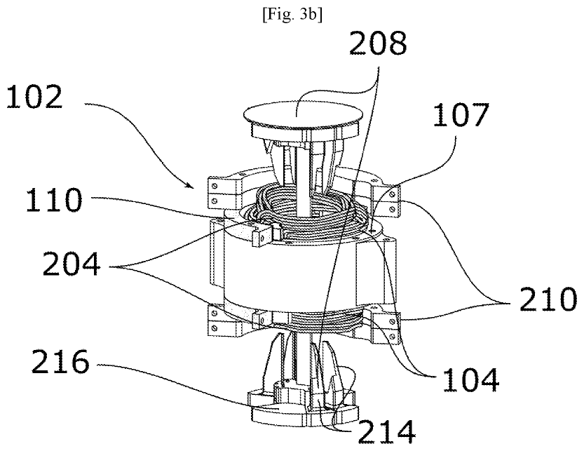

a definitive shaping step 18 by compacting the heads of the coils of said coil group into a predetermined shape, by a preconfigured apparatus. This shaping is for example effected by an apparatus which will be for example described hereinafter with reference to FIGS. 2a, 2b, 3a and 3b.

If a coil group is to be subsequently installed and/or if a coil connection to a power supply requires insulation, the installation steps applied to the current coil group comprise a step 20 of placing insulation on the compacted coil heads.

One step 22 makes it possible to verify whether a coil group remains to be installed. If this is the case, the new coil group is installed according to the installation steps 14 (according to the loop 24 of the installation steps). If there are no more coil groups to be installed, a finalization step 26 is implemented, which comprises for example connecting each coil to its dedicated power supply, in accordance with power supply methods of the prior art (single pole or multi-pole, single-phase or polyphase, etc.).

The definitive shaping step 18 can comprise, in this embodiment, a step 28 of bringing a coil group to temperature. This step 28 of bringing to temperature consists for example of using an oven, a Joule effect or another technique to heat the coil heads to a temperature greater than 100° C., sometimes higher depending on the material used, when the coil heads are constrained during compacting. After cooling, the constraint of the compacting is lifted and the coil heads retain their definitive shaping in compacted shape.

FIG. 2a and FIG. 2b are schematic, perspective views of an electric machine 100 and an assistance device 102 in accordance with one embodiment of the invention, during a first and second step respectively of installing a first coil group 104 in accordance with an installation method in accordance with one embodiment of the invention. FIG. 2a shows the electric machine once the coils of the first coil group are installed in the slots and FIG. 2b shows the placing of the apparatus allowing the definitive shaping of the coil heads of the first coil group.

The electric machine 100 is for example a stator of an electric motor, which comprises slots 106. The first coil group 104 (filled with a hatching pattern going from top-left to bottom-right) installed in the electric machine 100 comprises a visible part which protrudes from the slots 106, forming the coil heads. The electric machine 100 can be held by an apparatus 107.

Shaping of the coil heads, during the definitive shaping step by compacting the coil heads, is achieved using a first apparatus of the assisting device 102, for example in this case a compression tool 108 configured to exert a force on the coil heads according to one or more radial components and a shaping tool 110 (filled with a dot pattern) surrounding the coil heads and configured such that the coil heads bear against the inner surface 112 of the shaping tool 110 when they are compressed by the compression tool 108.

In particular, the compression tool 108 comprises, in this embodiment, inclined blades 114 which, when the compression tool 108 moves along the axis of the electric machine, exerts an increasing force on the coil heads to compress them on the inner surface 112 of the shaping tool 110. The compression tool 108 also comprises, in this embodiment, an axial compression surface 116. Compacting of the coil heads is thus three-dimensional owing to the radial bearing by the blades 114 and the axial bearing by the axial compression surface 116. The blades 114 can be configured to enter only the free slots, so as not to act on the coils already installed in the slots. The axial compression surface 116 makes it possible to compact the coil heads in a direction perpendicular to a surface 117 which is visible in FIG. 2a.

FIGS. 3a and 3b are schematic, perspective views of an electric machine 100 and an assistance device 102 in accordance with one embodiment of the invention, during a first and second step respectively of installing a second coil group in accordance with an installation method in accordance with one embodiment of the invention. FIG. 3a shows the electric machine once the coils of the second coil group are installed in the slots and FIG. 3b shows the placing of the apparatus allowing the definitive shaping of the coil heads of the second coil group.

In an identical manner to that described with respect to FIGS. 2a and 2b, the second coil group 204 (filled with a hatching pattern going from top-right to bottom-left) comprises coil heads protruding from slots in the electric machine 100. The coil heads of the second coil group 204 are arranged above the coil heads of the first coil group 104 already definitively shaped by compacting.

Shaping of the coil heads of the second coil group 204 is implemented by a second apparatus of the assistance device 102, comprising in this case a compression tool 208 comprising blades 214 and an axial compression surface 216, and a shaping tool 210 complementary to the shaping tool 110 for the first coil group 110 remaining in place. The shaping tool 210 comprises an inner surface 212 which can be of a different shape to that of the shaping tool 110 for the first coil group, as shown in particular in FIG. 3a. The compression tool 208 used for the second coil group can be the same as that used for the first coil group, wherein the number of blades can be adapted based on the free slots to the step in which it is used.

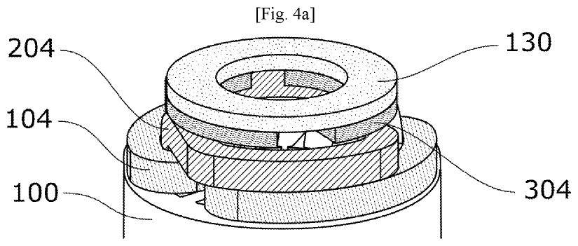

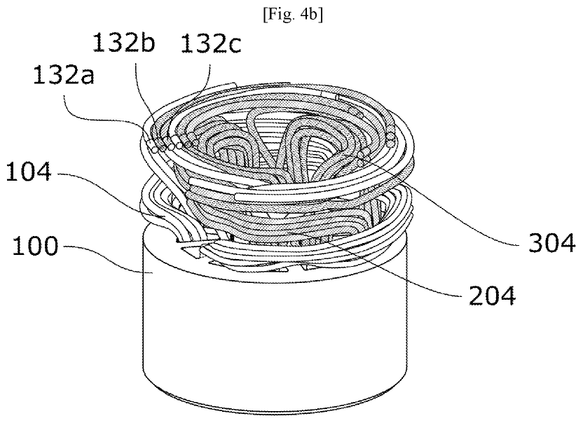

FIGS. 4a and 4b are schematic, perspective views of an electric machine in which coil groups have been installed by an installation method in accordance with one embodiment of the invention, in a simplified version and a more realistic version respectively.

In FIG. 4a, the simplified version shows three installed coil groups having their coil heads definitively shaped by compacting, a first coil group 104, a second coil group 204 and a third coil group 304 (filled with a horizontal wavy line pattern) respectively. Each shaped coil group takes up a space substantially extended in a different main plane for each coil group, the main planes of the coil groups being substantially parallel. If it is necessary to place insulation on the coil heads, this insulation can be arranged substantially in a plane parallel to the main planes of the coil groups, between two main planes of coil groups which must be insulated with respect to each other. Furthermore, insulation can be provided to prevent contact between the coil groups between the slots of the electric machine and the main plane taken up by each coil group. In particular, the second coil group must be insulated from the first coil group between the slots of the electric machine and the main plane taken up by the second coil group, and the third coil group must be insulated from the first coil group and the second coil group between the slots of the electric machine and the main plane taken up by the third coil group.

The coil heads have in this case a connection zone 130 (filled with a dot pattern) overlying them, said connection zone comprising conductors which can be connected to a power supply. In accordance with other embodiments, the connection conductors can be arranged in a different way.

FIG. 4b shows the conductors of each coil group. The coil groups each comprise connectors which are present in the connection zone 130 above the coil heads definitively shaped by compacting. In particular, a connector 132a allows the connection of a coil of the first coil group 104 (plain filling, without a pattern, for increased clarity), a connector 132b allows the connection of a coil of the second coil group 204 and a connector 132c allows the connection of a coil of the third coil group 304. A connector can be connected to an inlet or an outlet of a power supply.

The invention is not limited to the embodiments described. In particular, the assistance device can use other types of apparatus for the compression, the coils can be of different shapes, etc.

1. A method for installing coil groups in an electric machine, each of the coil groups comprising at least one coil, each said coil being composed of a plurality of turns of conductors, the method comprising installation steps for each of the coil groups applied thereto before being applied to a following one of the coil groups:
inserting a first one of the coil groups into at least two free or partially occupied slots of the electric machine, wherein portions of the at least one coil which are arranged outside the slots form coil heads,
shaping the coil heads by compacting the coil heads into a predetermined shape, by a preconfigured apparatus.

2. The installation method as claimed in claim 1, further comprising placing insulation on the compacted coil heads responsive to a corresponding one of the coil groups is to be subsequently installed and/or if a coil connection to a power supply requires said insulation.

3. The installation method as claimed in claim 1, wherein each of the coil groups is shaped so as to take up a space substantially extended in a different main plane for each of the coil groups, the main planes of the coil groups being substantially parallel.

4. The installation method as claimed in claim 3, wherein insulation is arranged substantially in a plane parallel to the main planes of the coil groups, between two main planes of the coil groups which must be insulated with respect to each other.

5. The installation method as claimed in claim 1, wherein the shaping comprises, for at least one of the coil groups bringing the at least one of the coil groups to temperature.

6. The installation method as claimed in claim 5, wherein the step (28) of bringing the at least one of the coil groups to temperature comprises heating the at least one of the coil groups held in compacted shape to a temperature greater than or equal to 100° C. for a predetermined duration, cooling the at least one of the coil groups held in compacted shape, and relaxing the compacting of the cooled at least one of the coil groups.

7. The installation method as claimed in claim 1, wherein the shaping comprises compacting according to at least one component, compacting the coil heads in a direction perpendicular to a surface of the electric machine and towards said surface of the electric machine.

8. The installation method as claimed in claim 1, wherein the shaping comprises compacting according to at least one component, compacting the coil heads in a direction perpendicular to a main axis of the electric machine in a compacting direction directed away from said main axis of the electric machine and towards the exterior of the electric machine.

9. A device assisting the installation of a coil group amongst coil groups of an electric machine, each of the coil groups comprising at least one coil, each said coil being composed of a plurality of turns of conductors, device being, configured to perform, after installation of each coil of the coil group, shaping by compacting, the shaping comprising inserting a first one of the coil groups into at least two free or partially occupied slots of the electric machine, wherein portions of the at least one coil which are arranged outside the slots form coil heads, and shaping the coil heads by compacting the coil heads into a predetermined shape,
the device comprising:
a compression tool configured to exert a force on the coil heads according to one or more radial components and
a shaping tool surrounding the coil heads and configured such that the coil heads bear against an inner surface of the shaping tool when they are compressed by the compression tool.

10. An electric machine, comprising slots intended to receive coils, the machine comprising coil groups installed by, after installation of each coil of a coil group amongst the coil groups, inserting a first one of the coil groups into at least two free or partially occupied slots of the electric machine, wherein portions of the coil which are arranged outside the slots form coil heads, and shaping the coil heads by compacting the coil heads into a predetermined shape.
